(19) United States
(12) Patent Application Publication
(10) Pub. No.: US 2024/0029084 A1
(43) Pub. Date: Jan. 25, 2024

(54) Real Estate

(71) Applicant: John Douville, Tacoma, WA (US)

(72) Inventor: John Douville, Tacoma, WA (US)

(21) Appl. No.: 17/871,926

(22) Filed: Jul. 23, 2022

(51) Int. Cl. G06Q 30/02; G06Q 50/16

(52) U.S. Cl. CPC G06Q 30/0201; G06Q 50/16

(57) ABSTRACT

Buyer locator systems may receive locate a buyer for a seller. For example, a buyer locator system may receive a buyer offer from a buyer, a seller offer from a seller and select a buyer based on a comparison between the buyer offer and the seller offer. The seller may be notified of the selected buyer, for example.

### FIELD

This disclosure relates generally to finding potential buyers including associated intermediaries.

### BACKGROUND

Computing systems are used to find potential buyers of properties. Protection of the identities of sellers of properties by computing systems is of limited scope and the identities of the sellers are subject to misappropriation or unauthorized disclosure and use.

### SUMMARY

The instant application discloses, among other things, buyer locator systems, which may be computer components configured to search for potential buyers having a high degree of interest in a property to be sold by a seller. Buyer locator systems may be configured to generate and control electronic communications between sellers (e.g., potential sellers), buyers (e.g., potential buyers), agents thereof, and other intermediaries. The communications may be generated by a buyer locator system so as to give each of the users of the system an interactive or personalized experience. The generated communications are logged so as to maintain records of communications that disclose to the seller (or their agent) a buyer offer of features of a property for sale and to maintain records of communications that disclose to the seller (or their agent) the identity of the buyer having the buyer offer.

A buyer locator system may select potential buyers to be disclosed to an undisclosed seller based on a comparison metric indicating a degree of a similarity of features of a respective buyer offer to features of the property to be sold by the (as-of-yet) undisclosed seller.

The disclosure of the selected buyer information to a seller (or their agent) may be conditioned upon acceptance by the seller (or their agent) of a first click-through license by which access to the buyer information is granted. The disclosure of a first portion of buyer information (e.g., a buyer offer for particular property features) to a particular seller (or their agent) may be controlled and logged by linking the first portion of disclosed buyer information to the seller (or their agent) who accepts the first click-through license (e.g., terms of which are accepted in exchange for the disclosure of the first portion of buyer information). The disclosure of a second portion of buyer information (e.g., buyer identity) to the particular seller (or their agent) may be controlled and logged by linking the second portion of disclosed buyer information to the seller (or their agent) who accepts the second click-through license (e.g., terms of which are accepted in exchange for the disclosure of the second portion of buyer information).

Compliance with duties and terms agreed-to by accepting the click-through licenses may be monitored by comparing the logged data associated with the licensees of the accepted click-through licenses against data associated with a subsequent sale of the seller's property. A buyer locator system may deprecate future activity by parties indicated to have not complied with their agreed-to terms and conditions.

Buyer locator systems may include communication ports by which devices of multiple entities may communicate with a buyer locator system. A buyer locator system may be communicatively coupled to remote clients and systems using various networks coupled to other networks such as local networks or the Internet. The coupled-to networks may include processing elements configured to execute services in containers for locating potential buyers. According to one example, buyer locator systems may include a server configured to communicate electronically (e.g., using an Internet Protocol) with a device of each respective entity. The devices of the various parties may have cabled, cellular, Radio-Frequency Identification (RFID), Wi-Fi, Bluetooth, or Near-Field Communication (NFC) capabilities that may be communicably coupled to local networks or the Internet, for example. This disclosure relates generally to electronic location of potential buyers.

### BRIEF DESCRIPTION OF THE DRAWINGS

Networked computing systems may serve as buyer locating tools for multiple entities. Many networked computing systems are limited in scope in terms of the ability to easily and securely locate potential buyers for property sellers and to selectively disclose relevant information based on input from multiple entities.

FIG. 1 illustrates Buyer Locator Network 100, according to one embodiment.

FIG. 2 illustrates Buyer Locator System 200, according to one embodiment.

FIG. 3 illustrates Locator Neural Net 300, according to one embodiment.

FIG. 4 illustrates Process 400 for a seller searching for a buyer, according to one embodiment.

FIG. 5 illustrates User Interface 500 for entering seller offers and for buyer offers, according to one embodiment.

FIG. 6 is a component diagram of computing system 600 to which a process described herein may be applied according to one embodiment.

FIG. 7 illustrates buyer locator Process 700 according to another embodiment.

Like reference numerals are used to designate like parts in the accompanying drawings.

### DETAILED DESCRIPTION

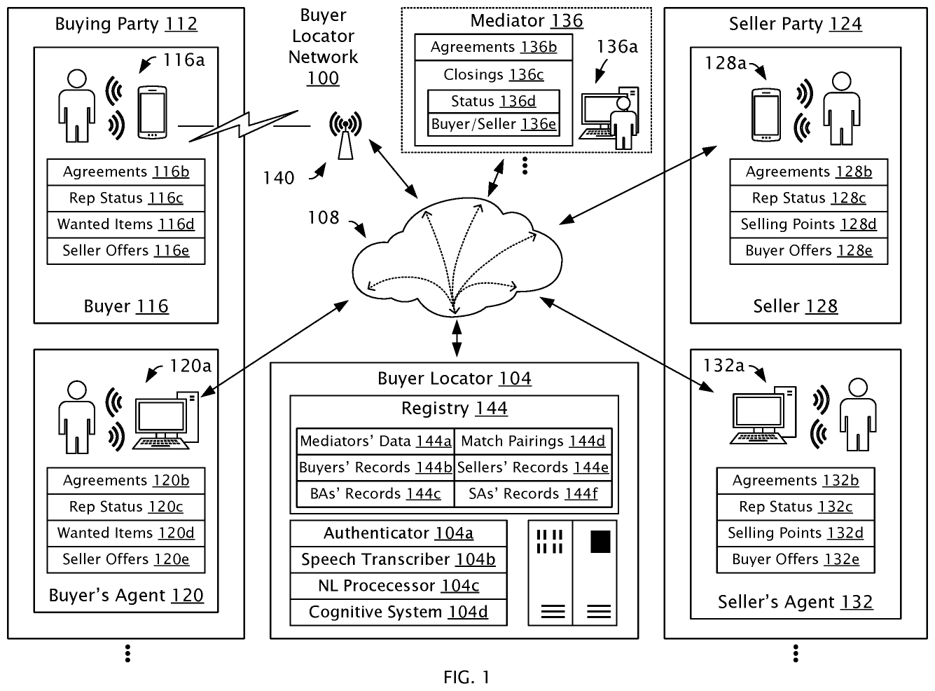

FIG. 1 illustrates Buyer Locator Network 100, according to one embodiment. Buyer Locator Network 100 may include Buyer Locator 104. Buyer Locator 104 may be communicably coupled to Network 108 (such as a network including remotely distributed processing elements), which in turn may be coupled (directly or indirectly) to Buying Party 112 (such as Buyer 116 and optionally Buyer's Agent 120) and to Seller Party 124 (such as Seller 128 and optionally Seller's Agent 132). Network 108 may be coupled (directly or indirectly) to Mediator 136a in a situation where both the Buying Party 112 is not represented by a Buyer's Agent 120 and the Seller Party 124 is not represented by a Seller's Agent 132.

Buyer Locator 104 may subdivide its tasks into processing portions and send selected processing portions to various processing elements (local or remote) for shared or parallel execution. Buyer Locator 104 may communicate with an instance of Mediator 136a, with multiple instances of Buying Party 112 (such as Buyer 116 and Buyer's Agent 120), and with an instance of Seller Party 124 (such as Seller 128 and Seller's Agent 132).

Buyer Locator 104 may be arranged to communicate with Buying Party 112 and Seller Party 124 via Network 108 to locate potential buyers for evaluation by sellers based on values (e.g., terms) and information provided by the Buying Party 112 and the Seller Party 124.

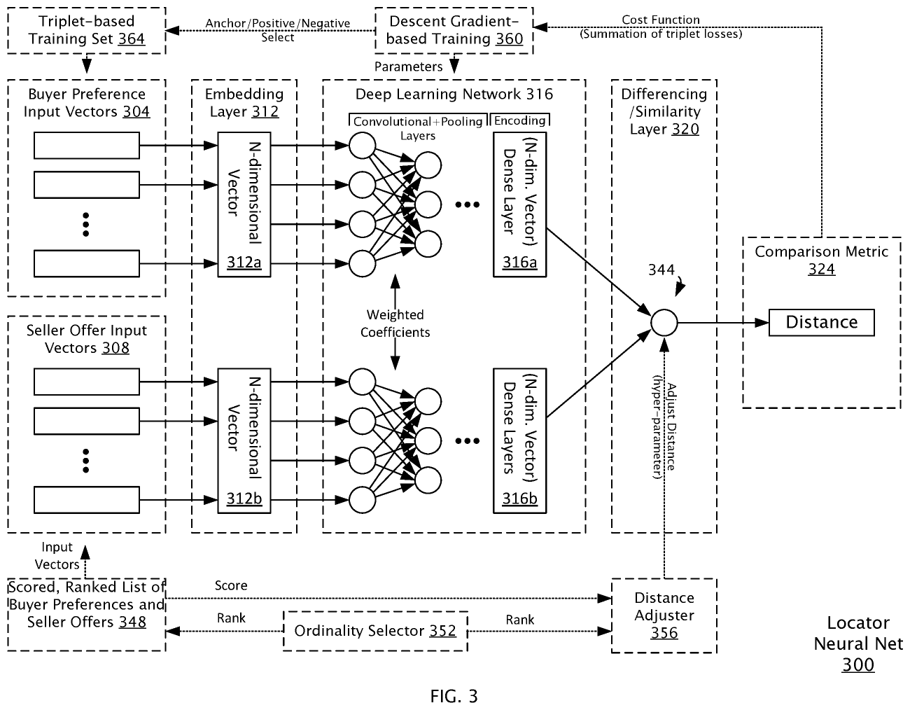

Buyer 116 may be User 116a operating a device (e.g., a cell phone having a thin client coupled to Network 108 via Cellular Service Provider 140) that includes Agreements 116b, Representation Status (“Rep Status”) 116c, Wanted Items 116d, and Sellers Offers 116e. Agreements 116b may be agreements accepted by Buyer 116 such as representation agreements, buyer locator licenses, and sales agreements (e.g., such as provided by Buyer Locator 104). Representation Status 116c may indicate a particular Buyer's Agent 120, a desire for the Buyer Locator 104 to choose a Buyer's Agent 120 for the Buyer 116, an indication of a desire for self-representation by the Buyer 116, or an indication of a desire for mediation. Wanted Items 116d may indicate a Buyer 116 preference for certain features and property attributes that the Buyer 116 desires in a property to be bought by the Buyer 116 (such as described below with respect to FIG. 3). Sellers Offers 116e may include seller offers selected by the Buyer 116 for browsing, for viewing, or for accepting or counteroffering.

Similarly, Buyer's Agent 120 may be User 120a operating a device (e.g., a desktop computer having a thin client) that includes Agreements 120b, Representation Status (“Rep Status”) 120c, Wanted Items 120d, and Sellers Offer 120e, each of which is associated with a particular Buyer 116 being represented by Buyer's Agent 120. Agreements 120b may be agreements accepted by Buyer's Agent 120 such as representation agreements, non-disclosure agreements, buyer locator licenses, and sales agreements (e.g., such as provided by Buyer Locator 104). Representation Status 120c may indicate the particular Buyer 116 and whether Buyer's Agent 120 agency of Buyer 116 is actively registered with the Buyer Locator 104. Wanted Items 120d may indicate information such as information indicated by Wanted Items 116d. Seller Offers 120e may indicate information such as indicated by information indicated by Seller Offers 116e. The sharing of information between the Buyer 116 and the Buyer's Agent 120 maintains coherency between the users of the Buying Party 112 and informs the Buyer's Agent 120 of the duties (e.g., confidentiality agreements) to be performed by the Buyer 116.

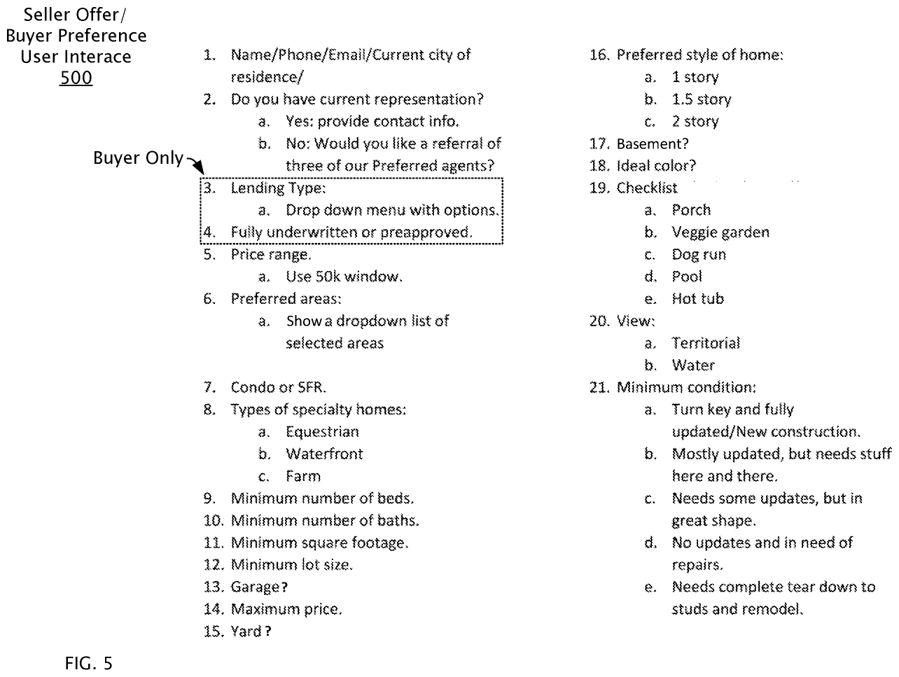

Seller 128 may be User 128a operating a device (e.g., a cell phone having a thin client coupled to Network 108) that includes Agreements 128b, Representation Status (“Rep Status”) 128c, Selling Points 128d, and Buyer Offers 128e. Agreements 128b may be agreements accepted by Seller 128 such as representation agreements, buyer locator licenses, and sales agreements (e.g., such as provided by Buyer Locator 104). Representation Status 128c may indicate a particular Buyer's Agent 120, an indication of a desire for the Buyer Locator 104 to choose a Seller's Agent 132 for the Seller 128, an indication of a desire for self-representation by the Seller 128, or an indication of a desire for mediation. Selling Points (e.g., of a seller offer) 128d may indicate Seller 128 representations for certain features and property attributes that the Seller 128 believes to be descriptive of the seller property to be bought by a Buyer 128 (such as described below with respect to FIG. 5). Buyer Offers 128e may include buyer offers proffered by a Buyer 116 made in response to a seller offer conveyed to the particular Buyer 116.

Similarly, Seller's Agent 132 may be User 132a operating a device (e.g., a desktop computer having a thin client) that includes Agreements 132b, Representation Status (“Rep Status”) 132c, Selling Points 132d, and Seller Offers 132e, each of which is associated with a particular Seller 128 being represented by the Seller's Agent 132. Agreements 132b may be agreements accepted by Seller's Agent 132 such as representation agreements, buyer locator licenses, and sales agreements (e.g., such as provided by Buyer Locator 104). Representation Status 132c may indicate the particular Seller 128 and whether Seller's Agent 132 agency of Seller 128 is actively registered with the Buyer Locator 104. Selling Points 132d may indicate information such as information indicated by Selling Points 128d. Buyer Offers 132e may indicate information such as indicated by information indicated by Buyer Offers 128e. The sharing of information between the Seller 128 and the Seller's Agent 132 maintains coherency between the users of the Seller Party 124 and informs the Seller's Agent 132 of the duties (e.g., confidentiality agreements) to be performed by the Seller 128.

Mediator 136 may participate in an example Buyer Locator 104 process in situations where neither the Buying Party 112 (e.g., Buyer 116) or the Seller Party (e.g., Seller 128) has indicated that they respectively desire to be represented by an Agent. Mediator 136 may control a purchasing process (e.g., a real estate closing of a sale agreement) for each of a number of Buyer 116/Seller 128 pairs for which a particular buyer has responded (e.g., via an acceptance or counteroffer) to a particular seller's offer.

Mediator 136 may be User 136a operating a device (e.g., a desktop computer having a thin client coupled to Network 108) that includes Agreements 136b and Closings 136c. Agreements 136b includes Agreements 116b, Representation Status 116c, Wanted Items 116d, Sellers Offers 116e, Agreements 128b, Representation Status 128c, Selling Points 128d, and Buyer Offers 128e. The sharing of information of the Buyer 116 and Seller 128 with Mediator 136 maintains coherency of shared information and informs the user 136a of the duties (e.g., confidentiality agreements) to be performed by the various parties of each Buyer/Seller pair. Closings 136c includes the status 136d of the closing for each Buyer/Seller pair 136e and informs Buyer Locator 104 of each change of status 136d (e.g., in response to each change or as polled by Buyer Locator 104).

Buyer Locator 104 may be a server, which may include (e.g., instantiate) Registry 144, Authenticator 104a, Speech Transcriber 104b, Natural Language (NL) Processor 104c, and Cognitive System 104d.

Registry 144 includes information associated with each Buyer 116, each Buyer's Agent 120, each Seller 128, each Seller's Agent 132, and each Mediator 136. Such information may be stored as Mediators' Data 144a, Buyers Records 144b, Buyers' Agents (BAs') records 144c, Match Pairings 144d (e.g., each Buyer offer selected for presentation to a Seller), Seller's Records 144e, and Seller's Agent Records (SAs') 144f. Each of the Buyers, Buyer's Agent, Sellers, Seller's Agents, and Mediators may be actively registered (e.g., enrolled) with Buyer Locator 104 before engaging in pairing and matchmaking processes (such as locating a suitable buyer of a property of an anonymous seller).

Each of Authenticator 104a, Speech Transcriber 104b, Natural Language Processor 104c, and Cognitive System 104d may be used to enroll external parties (such as Buying Party 112 or Seller Party 124) in Registry 144. For example, the enrollment process may include obtaining registration information (e.g., name, address, and various business information) for each external party to be enrolled, type of enrollee (e.g., Buyer, seller, agent, or mediator) and capturing authentication information (which may be authorization information such as passwords, user response timing, gestures, voiceprints, video, images, device fingerprinting for hardware authentication, and other quantified performance characteristics for identifying a user). Registry 144 may optionally store business information such as government or professional association registration numbers of licensed practitioners, affiliations, and social networking information. After the enrollment, Buyer Locator 104 serves as an intermediary agent for transferring and routing each communication (e.g., all communications) between any two of the external enrollees.

Providing computing components for the authentication, transcription, and natural language processing of speech as components located within Buyer Locator 104 allows clients to be “thin,” which may decrease overall costs while increasing overall security. For example, the authentication, transcription, and natural language processing of speech are relatively expensive, highly trained, highly complex, and memory- and processing-intensive functions. Co-locating and executing these functions within Buyer Locator 104 allows these functions to be provisioned in a single server system (e.g., for which enhanced measures for physical and networking security may be more securely and efficiently implemented).

In an example, Buyer Locator 104 may receive a user input generated by an external enrollee, such as User 116a. The user input may indicate an action to be taken by Buyer Locator 104. The generated user input may include (e.g., be associated with) quantifiable performance characteristics used to generate the user input. The quantifiable performance characteristics may include physical actions, which may be evaluated in time, space, frequency, acoustic, and image domains (and combinations thereof). The physical actions may include User 116a speech formants and patterns, facial characteristics (and changes in expression thereof, such as changes made in response to User 116a being told to “Smile!”), keystroke cadences and other ideosyncratic characteristics for authenticating User 116a. Such authentication may include evaluating and comparing quantifiable performance characteristics of the user input against the quantifiable performance characteristics previously determined to be manifested by User 116a during a secure session. Agents of a principal (e.g., such as Buyer 116 or Seller 128) may be electronically authenticated and authorized to represent the principal. Authenticator 104a may be (or may include) a machine learning-based model that is trained based on performance characteristics captured during a secure enrollment session of a particular user.

Authenticating the speech (and the concomitant performance characteristics thereof) of the actual received user input as speech that is affirmed to be spoken by User 116a helps prevent deceptive exploits such as person-in-the-middle, machine-generated speech, spoofing, and replay attacks. Person-in-the-middle attacks may be detected based on a rule indicating that a verbal input made by a person other than User 116a would likely include formants that are different from formants speech originated by User 116a. Machine-generated speech may be detected based on a rule that machine-generated speech would be more likely to respond artificially (e.g., unnaturally) to system prompts to a putative (e.g., imposter/unauthenticated) User 116a. Spoofing attacks may be detected based on a rule that User 116a would not likely engage in an excessive (e.g., above a threshold determined by a continuously trained model for inputs generated by a respective User 116a) number of inputs received from a particular enrollee.

Speech Transcriber 188 may evaluate the authenticated input speech to transcribe the spoken words of a user input into text (e.g., electronic code) to generate a transcribed user input. The transcribed user input may express (e.g., by using text) an intent (e.g., to select an agent offered by Buyer Locator 104. The transcribed user input may be expressed as text using the natural language as spoken by the user. However, such language may be unsuitable to be immediately executed or directly used by a server.

Natural Language Processor 104c may process the transcribed user input to determine an intent and entities (e.g., express, or implied, entities) expressed via the input. Natural Language Processor 104c may determine an intent and entities of the input using natural language processing based on machine leaning-based models and processing of the transcribed user input. An entity may be implicated based on an express mentioning in the user input or based on a context related to the determined intent. The determined intent and implicated entities may by expressed by Natural Language Processor 104c in a format (e.g., a data structure or descriptive code) which may be interpreted by a cognitive system.

Cognitive System 104d may receive the determined intent and implicated entities as structured information that conveys the determined intent and implicated entities. Cognitive System 104d may include a rules-based expert system or other cognitive model/neural network capable of parsing and compiling structured information. The structured information may be received from Natural Language Processor 104c as well as may be received from data stores by which Buyer Locator 104 generates structured documents for describing duties to be performed by each of the Buying Party 112 or the Seller Party 124. By using such systems and techniques, Cognitive System 104d may generate documents for real estate transactions based on the determined intent, the implicated entities, and associated information provided via data stores.

The Buyer Locator 104 may determine and enforce security policies for each communication occurring between any of the external enrollees. Avoiding direct external communication between any two external enrollees helps to maintain system coherency and may limit the potential for the external enrollees to avoid accepting click-through of licenses (in which acceptance of the license is required for disclosure of certain information). Arranging Buyer Locator 104 as a central arbiter between any pair of enrollees (e.g., registered in Registry 144) may enhance the value of the services of Buyer Locator 104 as being a trusted and “indispensable” go-between for the enrollees. Avoiding direct communication between any two external enrollees may also help preserve anonymity until such time disclosure of the identity of party would be necessary to generate a personal referral or sales agreement. Arranging Buyer Locator 104 as a central arbiter helps each enrollee to protect their own information from disclosure to other enrollees (who may compete with each other), which increases the security and value of each respective party's proprietary information.

After authentication, transcription, and natural language processing occurs as described in the example, Cognitive System 104d of the Buyer Locator 104 may select particular potential buyers having Wanted Items 116d closely matching the Selling Points 128d of an associated seller. The selected particular buyers (e.g., potential buyers) may be indicated (e.g., identified) to the associated seller in an authenticated session, so that (for example) the identity of the associated seller may be initially protected against immediate disclosure to any of the selected particular potential buyers.

Cognitive System 104d may control the disclosure of seller information to potential buyer (and agents thereof) based on acceptance of a click-through license. The disclosure of a first portion of buyer information (e.g., a preference of the buyer) to a particular seller (and to any agent thereof) may be controlled and monitored by associating the first portion of buyer information to each person accepting the click-through license in exchange for first information associated with the buyer offer. The disclosure of a second portion of buyer information (e.g., buyer identity) to a particular potential seller (and to any agent thereof) may be controlled and monitored by associating the second portion of buyer information to each person accepting the click-through license in exchange for second information associated with the buyer identity. Compliance with the click-through licenses may be monitored by comparing data associated with the licensees of the accepted click-through licenses against data associated with a subsequent sale of the seller's property. A buyer offer may be a buyer preference that includes information for informing the seller about the suitability of a particular for purchasing a property of the seller. The buyer offer may include information about a property the buyer would like to purchase (e.g., location, bedrooms, taxes, services) and may include information about the buyer itself (e.g., credit score, salary, and other legally cognizable information).

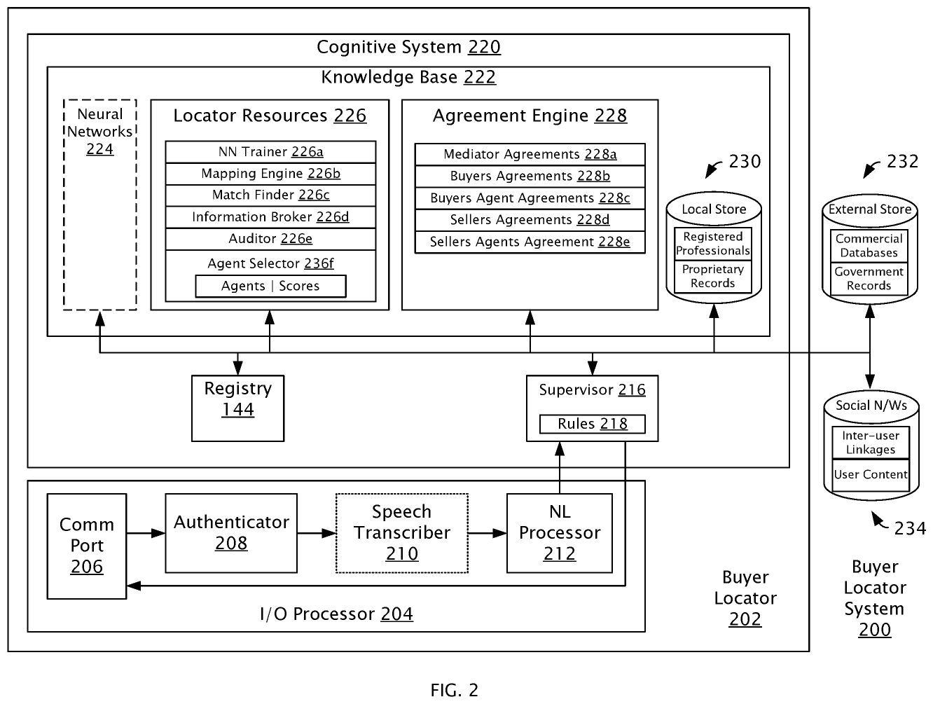

FIG. 2 illustrates Buyer Locator System 200, according to an embodiment. Buyer Locator System 200 includes Buyer Locator 202. Buyer Locator 202 may be a buyer locator such as Buyer Locator 104. Buyer locator 202 may include Registry 144, I/O Processor 204, and Cognitive System 220 (e.g., such as Cognitive System 104d).

Buyer Locator 202 may be networked to External Store 232 and Social Networks (“Social N/Ws”) 234. External Store 232 may include commercial information (such as commercial databases) and may also include government records (such as property records, property sales, title history, assessment values, tax history, tax and sale forms, law, regulations, codes, procedures, decrees, edicts, proclamations, orders, legislative history and policies, case law, reportings, findings, proceedings, sanction lists, and other authoritative content).

Social Networks 234 may be electronic systems managing the transfer of information between pairs (e.g., dyads) of actors (e.g., entities, users, or customers) within a social structure. Social Networks 234 may include information-based applications such as social media communications and blockchain hosting. The included information may include information such as inter-user linkages and user content. The inter-user linkages may indicate degrees of relationships in social media and blockchain between people (including legal entities). Degrees of relationships may be determined by mining (e.g., by artificial intelligence or analytical processes) user information such as user behavior, parties of blockchain transactions, and creators of social media content. Degrees of relationships may indicate a “closeness” (e.g., secondary, tertiary, quaternary, and further degrees of removal) or other affinity between social media users (e.g., commenters, group members, “friends,” or directly or indirectly linked-to colleagues). A degree of relationship between a pair of entities may be determined based on recursively inspecting a judgment expressed by later commenters replying (e.g., “liking,” using emojis, indicating varying degrees of favorable, neutral, or unfavorable tones, or otherwise expressing a personal reaction) to a message posted by respective previous commenter.

I/O processor 204 includes Communication Port (“Comm Port”) 206, Authenticator 208 (e.g., such as Authenticator 104a), Speech Transcriber 210 (e.g., such as Speech Transcriber 104b), and Natural Language (“NL”) Processor 212 (e.g., such as Natural Language Processor 104c). I/O Processor 204 is configured to send and receive messages across a network (e.g., such as Network 108). Network messages received at Communication Port 206 may be translated by I/O Processor 204 into a format readable by Supervisor 216 of the Cognitive System 220. Further, messages received by I/O Processor 204 from Supervisor 216 for transmission to externally networked systems may be formatted by I/O Processor 204 according to a format (e.g., Internet Protocol) that is supported by a network coupled to the Communication Port 206.

Cognitive System 220 includes Registry 144, Supervisor 216, and Knowledge Base 222. Supervisor 216 may be a rules-based inference engine configured to execute Rules 218. Rules 218 may be executed based on received user commands and may control the operation of elements and resources of Knowledge Base 222. Rules 218 may be executable for locating potential buyers for a particular seller based on information received from 1/O processor 204 (e.g., a user input having a determined intent) and based on information organized within or determined by Knowledge Base 222. Supervisor 216 is configured to provide services and serve web pages to external clients and devices.

Knowledge Base 222 includes Neural Networks 224, Locator Resources 226, Agreement Engine 228, and Local Store 230. Neural Networks 224 may include processing resources (e.g., processors, memory, and data) and may be implemented to apply artificial intelligence to any element of Cognitive System 220. Neural Networks 224 may be trained by Neural Net (“NN”) Trainer 226a (e.g., of Locator Resources 226) as described hereinbelow. Neural Networks 224 may include a neural network such as Locator Neural Net 300.

FIG. 3 illustrates Locator Neural Net 300, according to one embodiment. Locator Neural Net 300 is an example computer-implemented (e.g., artificial) neural network trained to determine a comparison metric between a seller offer of a property and a buyer offer for a property to be purchased. Locator Neural Net 300 may be a multiple-level neural network arranged (e.g., generally arranged) in accordance with a “Siamese” (e.g., twin, paralleled, or doubled) neural network architecture.

Locator Neural Net 300 may be instantiated by a programmable general-purpose processing system or may be implemented on special hardware such as neural network-architecture processors or field programmable gate arrays (FPGAs). In some examples, hardware elements of Locator Neural Net 300 may include permanently (or semi-permanently) formed connections by which the interconnections, the respective weights, and the activation functions of each neuron are implemented, so that a Locator Neural Net 300 may be implemented in non-volatile hardware based on values predetermined in training (e.g., before deployment of the Locator Neural Net 300).

Locator Neural Net 300 is arranged to receive Buyer Offer Input Vectors 304 at a first portion (e.g., upper level, as illustrated) of Locator Neural Net 300. Buyer Offer Input Vectors 304 may be provided based on indications of buyer offer from a buyer that may be received via a web-based interface and may be stored in List 348 (as described hereinbelow). Each input vector may represent a respective feature of the indicated buyer offer. Buyer Offer Input Vectors 304 are coupled to a first portion of an input layer, such as Embedding Layer 312. The first portion of Embedding Layer 312 may include a number of nodes arranged to generate an N-dimensional representation (e.g., N-dimensional Vector 312a) based on Buyer Offer Input Vectors 304. Embedding Layer 312 may apply (or otherwise associate) a particular weight to a corresponding one of the Buyer Offer Input Vectors 304. Each such weight may be selected based on an importance associated (e.g., determined during training) with a particular feature represented within the input feature data set. N-dimensional Vector 312a is coupled as an input to a first portion of Deep Learning Network 316.

Locator Neural Net 300 is further arranged to receive Seller Offer Input Vectors 308 at a second portion (e.g., lower level, as illustrated) of Locator Neural Net 300. Seller Offer Input Vectors 308 may be provided based on indications of an offer of a property by a seller that may be received via a web-based interface and may be stored in List 348 (as described hereinbelow). Each input vector may represent a respective feature of the indicated seller offer. Seller Offer Input Vectors 308 are coupled to a second portion of an input layer such as Embedding Layer 312. The second portion of Embedding Layer 312 may include a number of nodes arranged to generate an N-dimensional representation (e.g., N-dimensional Vector 312b) based on Seller Offer Input Vectors 308. Embedding Layer 312 may apply (or otherwise associate) a particular weight to a corresponding one of the Seller Offer Input Vectors 308. Each such weight may be selected based on importance associated (e.g., determined during training) with a particular feature represented within the input feature data set. N-dimensional Vector 312b is coupled as an input to a second portion of Deep Learning Network 316.

The first and second portions of Deep Learning Network 316 may be identical networks (e.g., subnetworks) that are arranged parallel with each other. In an example, each of the first and second subnetworks may include a succession of layers (e.g., intermediate layers, some of which may be “hidden” layers), in which each layer includes nodes (e.g., “neurons”). The nodes of a first layer (e.g., a preceding layer) may be concatenated to a subset of nodes of a second (e.g., a succeeding layer). A node of a first layer may be interconnected with multiple nodes of the second layer, so that each node of the second layer may be interconnected with a set of nodes of the first layer. Each node is configured to determine an output quantity (e.g., value, signal, or number) based on the values that are inputted to the particular node. The output quantity of a node may be determined by an activation function (which may be non-linear) associated with the particular node. The quantity determined by a node of a first layer may be outputted to interconnected nodes of a second layer by weighting (e.g., scaling) the output quantity and transmitting the weighted output quantity to the interconnected nodes of the second layer (e.g., so that the first and second layers are arranged in a feed-forward configuration). A particular weight can be assigned (e.g., during training) to a particular connection between a first and second node, so that each connection between a pair of nodes may be associated with a respective particular weight. In an example, the sum of the weights respectively assigned to each of the inputs of a node is unity or less.

The succession of layers in the first and second portions of Deep Learning Network 316 may each include a front-end, which includes convolutional layers (e.g., for pattern recognition) and pooling layers (e.g., for reducing the number of nodes in a layer, which reduces processing requirements). The succession of layers in the first and second portions of Deep Learning Network 316 may each include a back-end, which includes an encoding layer for generating an N-dimensional output vector in response to output quantities that are output by nodes of the respective front-end.

Dense Layer 316a (which may be fully connected) is configured to encode a first N-dimensional output vector based on N-dimensional Vector 312a, and Dense Layer 316b (which also may be fully connected) is configured to encode a second N-dimensional output vector based on N-dimensional Vector 312b.

Differencing/Similarity Layer 320 is arranged to receive the first and second N-dimensional output vectors (e.g., from Dense Layer 316a and Dense Layer 316b respectively) and is arranged to determine a distance between the two endpoints of the vectors. The distance determined between endpoints of each of the first and second N-dimensional output vectors may extend through the N-dimensional space (e.g., “hyperspace”) traversed by both the N-dimension output vectors. However, the distance between the two endpoints may be expressed as a scalar (e.g., expressed having a magnitude, but not having a direction).

In operation of Locator Neural Net 300, a Comparison Metric 324 may be a representation of a distance determined between an input vector representing a seller's offer (e.g., which is a representation of the property to be sold by the seller) and an input vector representing a buyer's (e.g., potential buyer's) preference. As disclosed herein, a Comparison Metric 324 may be generated based on a respective comparison made between the input vector that represents the seller's offer and a respective one the input vectors that represents a buyer offer. A record of each generated Comparison Metric 324 may be stored in Match Pairings 144d of Registry 144.

In conventional property sales, a property for sale may be publicly listed (by which the entire public might be able to determine the identity of the owner based on the description of the property). Based on the published listing, the buyer may notice the published listing and then reach out towards the seller with a view to purchase the property. However, disclosure of the property to be sold—as well as a public disclosure (or public indication) of the seller's identity—may expose either or both the property and the seller to potential harm by and from criminal elements of the public at large.

As disclosed herein, a neural network is arranged to generate a Comparison Metric 324, which may represent a distance between “what a buyer wants to buy” and “what a seller wants to sell.” Comparison Metric 324 may be used to select and introduce a potential buyer to the seller, so that the identity (or indications thereof) of the subject property or seller need not be disclosed to the public (or agents of the public) for the purpose of arranging an initial contact between a buyer and seller (or agents thereof). In an example, the Buyer Locator System 200 may send a communication linking a potential buyer to a seller without disclosing identifying features of the property of the seller. The identifying features of the property or seller may subsequently be disclosed to the potential buyer (or agent thereof) based on the potential buyer agreeing to an agreement that is conditioned upon the potential buyer and seller having a duty of loyalty (e.g., payment of a referral fee based on a future, actual sale of the subject property) to owners of a Buyer Locator System 200 and a duty to maintain the confidentiality of the buyer and the seller.

In an example, the identity of the seller is not initially published (e.g., so that the identity of the seller is maintained in confidence by Buyer Locator System 200). To avoid an initial disclosure of the identity of the seller to the public or a buyer, the seller may provide indications of a seller offer to Buyer Locator System 200, and—independently from actions taken by seller—a buyer (e.g., potential buyer) may provide indications of a buyer offer to Buyer Locator System 200. Buyer Locator System 200 may generate a Comparison Metric 324 based on the seller offer and a corresponding selected buyer offer. In the example, Buyer Locator System 200 may select the buyer offer for comparison based on the location (e.g., geospatial point) that the buyer offer indicates as being desirable to the buyer for buying a property. Based on the generated Comparison Metric 324, Buyer Locator System 200 may send a communication to the seller by which the seller may view an indication of a Comparison Metric 324 generated based on the seller offer and a buyer offer. The indication of Comparison Metric 324 may be a number, grade, color, “thermometer,” or any other device for conveying a degree of favorability of a particular buyer's preferences. The seller may also view indications of general information associated with the buyer offer being viewed.

In the example, the seller may select the buyer associated with the viewed buyer offer and may choose to progressively receive more information about preferences expressed by the buyer. Progressively providing more information about the buyer offers and the buyer identity helps increase the willingness of the seller to click-through a license agreement in order to obtain more specific information. Each progressive disclosure of information may be conditioned upon acceptance of a click-through agreement of duties owed by the buyer or seller. The seller's knowing (or guessing) that the click-through of the agreement by the seller with respect to a particular buyer might be logged by the Buyer Locator System 200 is helpful in encouraging the seller to abide by the duties in the clicked-through license.

In an example, a seller may register a property for sale by Buyer Locator System 200 by providing an indication (e.g., via a web-interface) of a Seller Offer for the property. The Locator Neural Net 300 of Buyer Locator system 200 is arranged to generate Seller Offer Input Vectors 308 based on the indication of the Seller Offer. The Locator Neural Net 300 is arranged to determine an offered geospatial point (e.g., the location of the property for sale) indicated by the Seller Offer. After the Seller Offer Input Vectors 308 are generated, the Locator Neural Net 300 may search Scored, Ranked List of Buyer Offer and Seller Offers 348 (e.g., List 348) to select a buyer offer listing based on the particular listing including an indication of a preferred geospatial point (e.g., a preferred location for a property that a particular buyer would like to purchase) that lies within a threshold distance from the offered geospatial point. Additional buyer offers (e.g., of other buyers) may be selected, viewed, and ranked by the seller based on the seller's view of favorability of a respective buyer offer. For each selected buyer offer listing, the Locator Neural Net 300 is arranged to generate a Buyer Offer Input Vectors 304 based on the indication of the selected buyer offer listing and is arranged to generate a Comparison Metric 324 based on both the Seller Offer Input Vectors 308 and a respective Buyer Offer Input Vectors 304. The Locator Neural Net 300 is arranged to select a matching selected buyer offer listing based on the generated Comparison Metric 324 and to output a communication indicating the selected matching buyer offer.

In an example, a seller may rank (e.g., select or prioritize) specific buyers offers (e.g., based on an impression of a price offered or terms of sale associated with a particular buyers offer) to help promote (or deprecate) a particular buyers offer. List 348 may be ordered by or indicate a rank or score. A communication indicating the selected matching buyer offer may be sent to a seller and may be based on the score or ranking of a selected matching buyer offer entry.

In an example, matching buyer offer entries (e.g., that are selected by a seller) may be presented (e.g., via a web-based interface) to the Seller based on the seller-ranking of the entries. Ordinality Selector 352 may present each of the selected matching buyer offer entry based of an ordinality of a ranking of the entry (e.g., first five entries, entries 10 through 15, and other ranges of entries. Presentation of buyer offers as ranked by the seller helps the seller to adjust system-generated comparison values in accordance with the sellers ranking, so the user may save browsing time and be provided with a customized user experience.

The score or ordinality of a particular entry in List 348 may be used to adjust the Comparison Metric 324 associated with the entry of the buyer offer being compared. The vectors associated with the particular entry of the buyer offer are represented by N-dimensional Vector 312a, and the vectors associated with the seller offer are represented by N-dimensional Vector 312b. The rank and score may be coupled to Distance Adjuster 356, so that the rank (e.g., a user-supplied metric) or the score (a system-supplied metric) may be used to adjust a distance (e.g., in hyperspace) between the endpoint of N-dimensional output vector of 316a and the endpoint of N-dimensional output vector of 316b. The sensitivity (e.g., degree of scaling) of the distance adjustment based on score or ranking may be adjusted based on re-scaling the linear units of an adjustment vector dimension relative to the scaling of linear units of other dimensions occupied by the N-dimensional output vectors of 316a and 316b. Based on the received score or ranking, Distance Adjuster 356 generates a distance adjustment hyper-parameter. The distance adjustment hyper-parameter (e.g., associated with an adjustment vector dimension) is received by output node 344, which may generate an adjusted Comparison Metric 324 based on the score or rank of the particular buyer offer entry.

Descent Gradient-based Training 360 using backpropagation may be performed initially or in operation in cooperation with Neural Net (“NN”) Trainer 226a. Descent Gradient-based Training may be based on vectors Triplet-based (e.g., containing anchor, positive, and negative training elements) Training Set 364. Each element of Training Set 364 may be selected for training Locator Neural Net 300 in a single epoch by Descent Gradient-based Training 360, a cost function may be determined based on Comparison Metrics 324 generated over the epoch, and parameters for configuring the Deep Learning Network 316 may be selected based on a cost function determined over the epoch. Configuration of the Locator Neural Net 300 may be optimized by minimizing the cost function over epochs of training performed during operation of the Descent Gradient-based Training 360.

With reference again to FIG. 2, Locator Resources 226 includes Neural Net (“NN”) Trainer 226a, Mapping Engine 226b, Match Finder 226c, Information Broker 226d, Auditor 226e, and Agent Selector 236f.

Neural Net (“NN”) Trainer 226a may be arranged to train Neural Networks 224 to apply artificial intelligence to any element of Cognitive System 220. An example training may include using a backpropagation technique as described hereinabove. In some embodiments, reinforcement learning feedback is used to fortify or reconfigure the weights assigned to the initial input features of the buyer offer and seller offer input vectors. The example training may include supervised learning tasks, in which parameters for configuring Deep Learning Network 316 may be determined based on comparison of network responses to a set of given inputs against predetermined “correct” network responses to the set of given inputs.

Mapping Engine 226b may be arranged to manipulate spatial and temporospatial information to provide input to Match Finder 226c. For example, Mapping Engine 226b may be arranged to correlate geospatial coordinates from a buyer offer and a seller offer to respective corresponding positions on an electronic map. Mapping Engine 226b may generate an image of an electronic map including an indication for each of the correlated geospatial coordinates and convey the generated electronic map image to a seller, buyer, or agent via a web-based graphical user interface (GUI). Mapping Engine 226b may also be able to provide time and distance estimates between two geospatial coordinates based on electronically generated routing, historical traffic data, and actual conditions based on a time of day. The time and distance estimates may be provided as a buyer offer input vector, or as a seller offer input vector.

Match Finder 226c may be arranged to receive indications of buyer offers and seller offers via a web-based GUI. Match Finder 226c may also determine relative locations of properties based on timing and distance information received from Mapping Engine 226b.

Match Finder 226c is arranged to determine a closeness of matches based on a comparison performed between each combination of a buyer offer and a seller offer. The buyer offer and seller offer to be compared may be selected based on a value an attribute (e.g., location, number of baths, and other such features) of the buyer offer and seller offer to be compared. Match Finder 226c may determine the closeness of matches by providing buyer offers and seller offers via List 348.

Match finder 226c may adjust (e.g., promote or deprecate) the prominence of a seller offer or a buyer offer in various Buyer Locator System 200 communications, where the adjustments may be based on results of evaluations performed by Auditor 226e.

Information Broker 226d is configured to generate a comparison between a seller offer and buyer offer. In an example, a seller is displayed indications of buyer offers (e.g., in a map image) including a location (e.g., geospatial point) of the seller property and a location (e.g., a highlighted area with centroid) indicated by a respective buyer offer. Each buyer offer may be displayed based on the similarity (e.g., comparison metric 324) to the seller property. The number of buyer offers to be presented on the map image may be based on the degree of similarity and the density of buyer offers to be displayed. (The display of buyer offers having the highest degrees of similarity helps eliminate clutter and save the seller time in reviewing buyer offers; this feature may be especially helpful in urban locations.)

The seller may click on an indication of a buyer offer to select a particular buyer reference. In response, Information broker 226d generates and displays generic description of the particular buyer reference (e.g., style of building, price range, number of bedrooms and baths) accompanied by a click-through license to accept as a condition of receiving specific information of the buyer or buyer agent. Upon receipt of an acceptance of the click-through license, Information Broker 226d may disclose specific information of the buyer offer (e.g., the identity of the buyer) to the seller.

Auditor 226e is configured to monitor adherence of System 200 enrollees (e.g., buyers, sellers, and respective agents) to duties agreed to via acceptance of a respective agreements. For example, an agreement may be a click-through license, by which a disclosure of information or a provision of services may be conditioned upon acceptance by the enrollee of the terms of the agreement.

The results of evaluations performed by Auditor 226e may be used to adjust (e.g., promote or deprecate) the selection of certain parties or adjust the prominence of related properties/preferences as presented by the Match Finder 226c. In an example, an opportunistic (e.g., unfaithful) agent might violate an agreed-to duty of non-disclosure by disclosing the name of a seller of a subject property to a social media friend. Auditor 234 may subsequently inspect public records to locate a record of sale of the subject property and determine whether any party indicated by the record of sale has a close degree of relationship to the seller or the opportunistic agent. Based on a determination that such a degree of relationship exists, a degree of “favorability” score of the indicated Seller or opportunistic agent can be deprecated (e.g., down-scored based on a strength of the determined degree of relationship between the seller and the opportunistic agent). The favorability score may be used to determine weights for ranking sellers, buyers, and their agents (e.g., if represented) that may be used in future matchmaking or selection of agents (e.g., that may be selected to represent currently unrepresented sellers or buyers who indicate a desire for representation).

Auditor 226e may perform audits of Buyer Location System parties based on accessing List 348 information. The audits may be continuously performed on an on-going basis so that later performed (and even performed years later) real estate transactions involving properties subject to non-disclosure agreements (e.g., that might otherwise be missed by a person) may be flagged. List 348 stores (e.g., as an entry in a list) an indication of each of the buyer offers and seller offers. Auditor 226e is arranged search data stores (e.g., Local Score 230, External Score 232, and Social Networks 234) to determine a history of a seller, buyer, or agent associated with a respective entry in List 348. The history may be evaluated by associating trustworthy ratings, credit ratings, or public sales records (e.g., to determine whether a party has potentially or likely violated an accepted agreement). In an example history determination, an entry may initially be associated with a neutral score: the initial score may be adjusted upwards in response to an evaluation of a history showing high ratings or good past performance or may be adjusted downwards in response to an evaluation of history showing low ratings or poor past performance. The score may be adjusted downwards, for example, based on a determination that a property has been sold by a party (or an outside party having a close degree of affinity to a party) in violation of an agreement associated with the subject party. Agents selected by Buyer Locator System 200 for unrepresented buyers or sellers may be selected based on a score determined by Auditor 226e.

Agent Selector 236f is arranged to maintain records and status of agents for sellers and buyers. An agent may be a licensed real estate agent, a licensed attorney, or a limited practitioner licensed by a cognizant government agency. Agent Selector 236f is arranged to prompt an agent for a representation agreement (e.g., for the representation of a buyer or seller by the agent) based on an indication that the principal (e.g., buyer or seller) has agreed to represent the principal. Agent Selector 236f may audit dates of expiration agreements of agents and revoke a representation status based on an expiration of a representation agreement.

Agents in good standing with a government licensing agency and that are available for representation may request to be registered by the Agent Selector 236f as a “preferred agent.” Registration as a preferred agent by Buyer Locator System 200 may be conditioned upon the agent to be registered accepting the duties to preserve confidentiality and pay a referral fee, where the accepted duties survive the expiration of active registration and expiration of associated representation agreements. Agent Selector 236f may recommend a preferred agent to a buyer or seller that has indicated a desire for representation but is not (or is no longer) represented by an agent.

Agent Selector 236f may select a preferred agent based on a random number, a score for the agent as generated by auditor 226e, or a combination of the random number and the score. A combination of the random selection and the score may include providing a bias to the otherwise random number (e.g., so that a slightly higher performing agent may receive a slightly higher number of referrals than would otherwise be received under a strictly random selection process).

In an example where a buyer or seller has not indicated a desire for self-representation, Agent Selector 236f may be arranged to select a “preferred agent” and to present the selected preferred agent to the unrepresented buyer or seller, so that the presented preferred agent may enter a representation agreement with one of the unrepresented buyer or seller. The Agent Selector 236f may require receipt of an executed representation agreement before registering the selected agent as the agent of the buyer or seller to be represented.

In an example, Agent Selector 236f is arranged to maintain records and work status of mediators. Agent Selector 236f may be configured to select a mediator for closing a sale between an unrepresented seller and an unrepresented buyer.

Agreement Engine 228 is arranged to serve an agreement to a respective party based on a context for which an agreement is a condition to receive services or information provided by Buyer Locator System 200. In an example, an agreement may be served during the registration of an external party (e.g., a buyer, a seller, or an agent thereof), during disclosure of a buyer offer to a seller or seller's agent, during disclosure of a seller offer to a buyer or buyer's agent, or during disclosure of an identity of a seller or seller's agent to a buyer or buyer's agent. In various processes of Buyer Locator System 200, acceptance of a served agreement is a prerequisite to receiving further services or further information provided by Buyer Locator System 200.

Agreement Engine 228 is arranged to record and maintain times and dates of acceptance by parties to each served agreement (and the context in which the agreements are served) with respect to an associated Mediator Agreements 228a, Buyers Agreements 228b, Buyers Agent Agreements 228c, Seller Agreements 228d, and Seller Agent Agreements 228e. Auditor 226e is arranged to access the records of Agreement Engine 228 and provide scores for a respective party based on indications of the respective party searched for within available data stores (e.g., Local Score 230, External Score 232, and Social Networks 234).

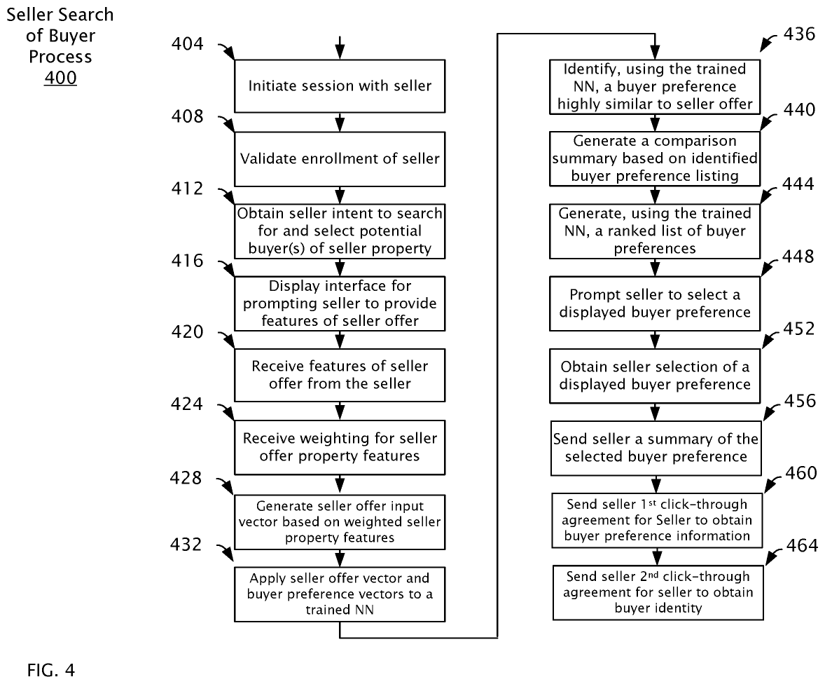

FIG. 4 illustrates Process 400, according to one embodiment. Process 400 may be a process for a seller search for a buyer. Process 400 may be executed by processors of Buyer Locator System 200 operating in a network such as Buyer Locator Network 100. In an example Process 400, Buyer Locator 104 may securely enroll a buying party (such as Buyer 116) and a seller party (such as Seller 128) as authenticatable users and/or registered entities of Buyer Locator System 200.

At 404 of Process 400, a session for a seller is initiated. The session may be a secure Internet-enabled session that may include video, audio, and keyboard-entered text of the seller.

At 408 of Process 400, the enrollment of the seller is validated. If the seller is not enrolled, the seller can be prompted to enroll.

At 412 of Process 400, a seller intent is determined to search for and to select potential buyers of seller property.

At 416 of Process 400, an interface for prompting a seller to provide features of a seller offer is displayed. The displayed interface may be similar to User Interface 500, as described hereinbelow with reference to FIG. 5.

At 420 of Process 400, features of the seller offer are received from the seller.

At 424 of Process 400, a weighting for respective property features of the seller offer is determined. Property features that are more important to the seller may be assigned heavier weights by the seller. Weights may also be assigned based on a condition of the property to be sold. For the purpose of comparing of features of the seller offer, weights may also be applied to corresponding features that are received in a listing of a buyer offer of a property to be purchased by the buyer.

At 428 of Process 400, a seller offer input vector is generated based on the features of the received seller offer and based on the respective assigned weights. A buyer offer input vector may also be generated based on property features of a buyer offer and the corresponding assigned weights.

At 432 of Process 400, the seller offer input vector and the buyer offer input vectors are applied to respective portions of a trained neural net to generate a comparison metric. Buyer offer input vectors from various other buyer offers may be applied to generate a list of comparisons with the seller offer input vector.

At 436 of Process 400, the buyer offer that is most highly similar to the seller offer may be identified by determining the buyer offer associated with the highest generated value of the comparison metric.

At 440 of Processor 400, a comparison summary based on the identified highly similar buyer offer is generated for display to the seller.

At 444 of Process 400, a ranked list of buyer offers (e.g., a ranked list of entries in which each entry includes a set of preferences of or for a respective buyer) is generated based on ordering buyer offers based on the value of the associated comparison metric. An entry of the ranked list of entries may include an indication of a selected buyer offer.

At 448 of Process 400, the seller is prompted to select a displayed buyer offer. The seller may select one or more buyer offers and may provide an indication the seller has finished selecting from the displayed buyer offers.

At 452 of Process 400, the selection of the displayed buyer offer by the seller is obtained.

At 456 of Process 400, a summary of the selected buyer offer is sent to the seller for display.

At 460 of Processor 400, a first click-through agreement is sent to the seller, which when accepted by the seller allows the seller to obtain buyer offer information (e.g., which is more detailed than the previously received summary of the selected buyer offer information).

At 464 of Processor 400, a second click-through agreement is sent to the seller, which when accepted by the seller allows the seller to obtain the identity of the buyer. After having obtained the identity of the buyer, the seller may reach out to the buyer (or an agent of the buyer) to attempt to pursue a sale of the subject property to the identified a buyer.

One having skill in the art will recognize that various ways of interacting with Buyer Locator System 200 may be implemented.

FIG. 5 illustrates User Interface 500 for entering seller offers and for buyer offers, according to one embodiment. User Interface 500 may be presented to a seller or a buyer. A seller responding to the prompts of User Interface 500, responds to the prompts by supplying information related to features of the property for which the seller intends to find a buyer. A buyer responding to the prompts of User Interface 500, responds to the prompts by supplying information related to features of the property for which the buyer intends to purchase. The responses supplied by the seller may be referred to as a “seller offer” (from which seller offer input vectors may be derived), and the responses supplied by the buyer may be referred to as a “buyer offer” (from which buyer offer input vectors may be derived).

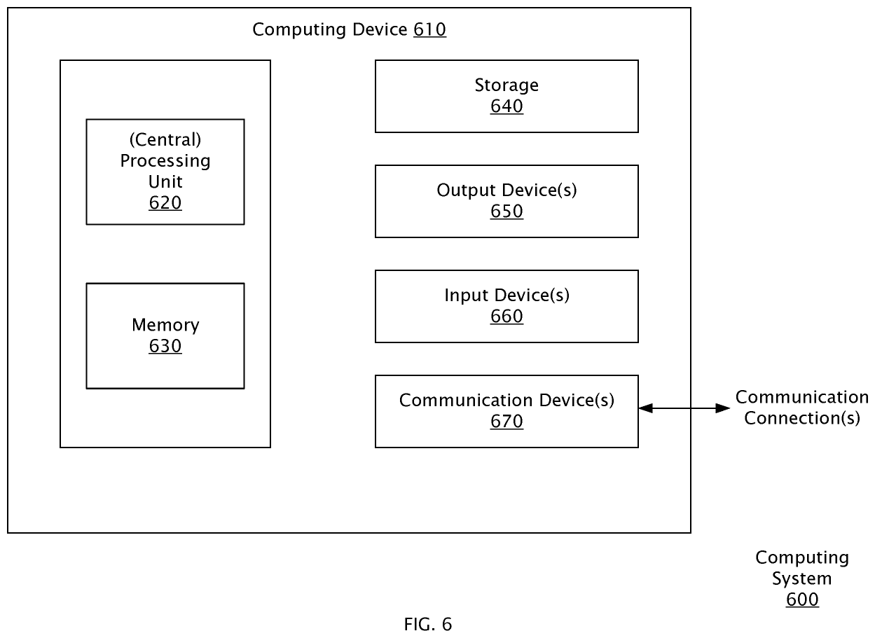

FIG. 6 is a component diagram of computing system 600 to which a process described herein may be applied according to one embodiment. The Computing Device 610 may be utilized to implement one or more computing devices, computer processes, machine learning-based models, neural networks, or software modules described herein, including, for example, but not limited to a mobile device. In one example, the Computing Device 610 may be used to process calculations, execute instructions, and receive and transmit digital signals. In another example, the Computing Device 610 may be utilized to process calculations, execute instructions, receive and transmit digital signals, receive and transmit search queries and hypertext, provide artificial intelligence, and compile computer code suitable for execution on a mobile device. The Computing Device 610 may be any general or special purpose computer now known or to become known capable of performing the steps and/or performing the functions described herein, either in software, hardware, firmware, or a combination thereof.

In a basic configuration, Computing Device 610 typically includes at least one Processing Unit (e.g., CPU) 620 and Memory 630. Depending on the exact configuration and type of Computing Device 610, Memory 630 may be volatile (such as RAM), non-volatile (such as ROM, flash memory, etc.) or some combination of the two. Additionally, Computing Device 610 may also have additional features/functionality. For example, Computing Device 610 may include multiple CPUs. The described methods may be executed in any manner by any processing unit in Computing Device 610. For example, the described process may be executed by both multiple CPUs in parallel.

Computing Device 610 may also include additional storage (removable or non-removable) such as solid-state “hard-drives,” magnetic or optical disks or tape. Such additional storage is illustrated in FIG. 6 by Storage 640. Computer readable storage media include volatile and nonvolatile, removable and non-removable media implemented in any method or technology for storage of information such as computer-readable instructions, data structures, program modules or other data. Memory 630 and Storage 640 are all examples of computer-readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may accessed by Computing Device 610. Any such computer-readable storage media may be part of Computing Device 610. But computer readable storage media do not include transient signals.

Computing Device 610 may also contain Communications Device(s) 670 that allow the device to communicate with other devices. Communications Device(s) 670 is an example of communication media. Communication media typically embody computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, radio frequency (RF), infrared and other wireless media. The term computer-readable media as used herein includes both computer-readable storage media and communication media. The described methods may be encoded in any computer-readable media in any form, such as data, computer-executable instructions, and the like. Computing Device 610 may also have Input Device(s) 660 such as keyboard, mouse, pen, voice input device, touch input device, etc. Output Device(s) 650 such as a display, speakers, printer, etc. may also be included. Such devices are well known in the art and need not be discussed at length.

Those skilled in the art will realize that storage devices utilized to store program instructions may be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions, may be carried out by a dedicated circuit, such as a digital signal processor (DSP), programmable logic array, or the like.

An example computing system 600 may include a processor communicatively coupled to a computing device; and a memory, coupled to the processor, configured to store executable instructions that, when executed by the processor, cause the processor to: train, by the processor, a neural net to generate a first N-dimensional vector based on a training buyer offer feature, to generate a second N-dimensional vector based on a training seller offer feature, and to generate a scalar based on a distance between respective endpoints of the first and second N-dimensional vectors; receive, by the processor, a buyer offer from a buyer, the buyer offer including a buyer offer feature of a property for purchasing by the buyer; receive, by the processor, a seller offer from a seller, the seller offer including a seller offer feature of a property for sale by the seller; generate, by the neural net, a comparison metric, the generating of the comparison metric based on generated scalar; select, by the processor, the buyer offer, the selecting of the buyer offer based on the comparison metric; and send, by the processor, an indication of the selected buyer offer to the seller.

Another example computing system 600 may include a processor communicatively coupled to a computing device; a neural net trained to generate a first N-dimensional vector based on a training buyer offer feature, to generate a second N-dimensional vector based on a training seller offer feature, and to generate a scalar based on a distance between respective endpoints of the first and second N-dimensional vectors; and a memory, coupled to the processor, configured to store executable instructions that, when executed by the processor, cause the processor to: receive a buyer offer from a buyer device of a buyer, the buyer offer including a buyer offer feature of a property for purchasing by the buyer; receive a seller offer from a seller device of a seller, the seller offer including a seller offer feature of a property for sale by the seller; generate a comparison metric, the generating of the comparison metric based on the trained neural net generating a scalar based on the buyer offer and the seller offer; select the buyer offer, the selecting of the buyer offer based on the comparison metric; and send an indication of the selected buyer offer to the seller device of the seller.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description show certain events occurring in a certain order. In alternative embodiments, certain operations may be performed in a different order, modified or removed. Moreover, steps may be added to the above-described logic and still conform to the described embodiments. Further, operations described herein may occur sequentially, or certain operations may be processed in parallel. Yet further, operations may be performed by a single processing unit or by distributed processing units.

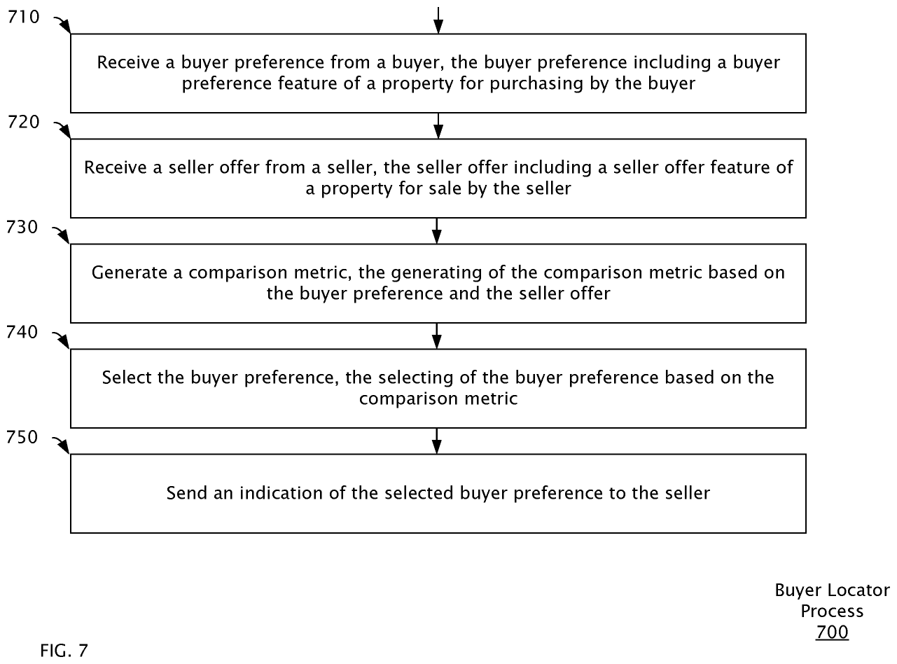

FIG. 7 illustrates buyer locator Process 700 according to another embodiment. In various embodiments Process 700 may be performed by processor executing instructions stored in memory.

At 710 of Process 700, a buyer offer is received from a buyer, the buyer offer including a buyer offer feature of a property for purchasing by the buyer.

At 720 of Process 700, a seller offer is received from a seller, the seller offer including a seller offer feature of a property for sale by the seller.

At 730 of Process 700, a comparison metric is generated, the generating of the comparison metric based on the buyer offer and the seller offer

At 740 of Process 700, the buyer offer is selected, the selecting of the buyer offer based on the comparison metric.

At 750 of Process 700, an indication of the selected buyer offer is sent to the seller.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data provide complete description of the manufacture and use of the invention. Since many embodiments of the invention may be made without departing from the spirit and scope of the invention, the invention resides in the claims hereinafter appended.

I/We claim:

1. A method for locating buyers, the method being performed by a processor executing instructions stored in memory and comprising:
receiving, by the processor, a buyer offer from a buyer, the buyer offer including a buyer offer feature of a property for purchasing by the buyer;
receiving, by the processor, a seller offer from a seller, the seller offer including a seller offer feature of a property for sale by the seller;
generating, by the processor, a comparison metric, the generating of the comparison metric based on the buyer offer and the seller offer;
selecting, by the processor, the buyer offer, the selecting of the buyer offer based on the comparison metric; and
sending an indication of the selected buyer offer to the seller.

2. The method of claim 1, further comprising:
sending, by the processor, a first click-through license to the seller, the first click-through license arranged to direct the processor to send to the seller an indication of the buyer offer feature of a property for purchase by the buyer.

3. The method of claim 2, further comprising:
sending, by the processor, a second click-through license to the seller, the second click-through license arranged to direct the processor to send to the seller an indication of the identity of the buyer.

4. The method of claim 1, further comprising:
sending, by the processor, a click-through license to the seller, the click-through license arranged to direct the processor to send to the seller an indication of the identity of the buyer.

5. The method of claim 1, wherein the buyer offer from a buyer is a first buyer offer from a first buyer, and further comprising:
receiving, by the processor, a second buyer offer from a second buyer, the second buyer offer including a second buyer offer feature of a property for purchasing by the second buyer.

6. The method of claim 5, wherein the comparison metric is a first comparison metric, and further comprising:
generating, by the processor, a second comparison metric, the generating of the second comparison metric based on the second buyer offer and the seller offer.

7. The method of claim 5, further comprising:
selecting, by the processor, the first buyer offer, the selecting of the first buyer offer based on the first comparison metric and based on the second comparison metric.

8. The method of claim 1, wherein the generating, by the processor, a comparison metric is performed by a neural net trained to generate a first N-dimensional vector based on the buyer offer feature, trained to generate a second N-dimensional vector based on the seller offer feature, and trained to generate a scalar based on a distance between respective endpoints of the first and second N-dimensional vectors.

9. The method of claim 8, wherein the generating, by the processor, a comparison metric is generated based on the scalar generated by the neural net.

10. The method of claim 9, further comprising:
sending, by the processor, a first click-through license to the seller, the first click-through license arranged to direct the processor to send to the seller an indication of the buyer offer feature of a property for purchase by the buyer; and
sending, by the processor, a second click-through license to the seller, the second click-through license arranged to direct the processor to send to the seller an indication of the identity of the buyer.

11. A method for locating buyers, the method being performed by a processor executing instructions stored in memory and comprising:
training, by the processor, a neural net to generate a first N-dimensional vector based on a training buyer offer feature, to generate a second N-dimensional vector based on a training seller offer feature, and to generate a scalar based on a distance between respective endpoints of the first and second N-dimensional vectors;
receiving, by the processor, a buyer offer from a buyer, the buyer offer including a buyer offer feature of a property for purchasing by the buyer;
receiving, by the processor, a seller offer from a seller, the seller offer including a seller offer feature of a property for sale by the seller;
generating, by the neural net, a comparison metric, the generating of the comparison metric based on generated scalar;
selecting, by the processor, the buyer offer, the selecting of the buyer offer based on the comparison metric; and
sending, by the processor, an indication of the selected buyer offer to the seller.

12. The method of claim 11, further comprising:
sending, by the processor, a first click-through license to the seller, the first click-through license arranged to direct the processor to send to the seller an indication of the buyer offer feature of a property for purchase by the buyer.

13. The method of claim 12, wherein the buyer offer from a buyer is a first buyer offer from a first buyer, and further comprising:
receiving, by the processor, a second buyer offer from a second buyer, the second buyer offer including a second buyer offer feature of a property for purchasing by the second buyer.

14. The method of claim 13, wherein the comparison metric is a first comparison metric, and further comprising:
generating, by the neural net, a second comparison metric, the generating of the second comparison metric based on the second buyer offer and the seller offer.

15. The method of claim 14, further comprising:
training, by the processor, the neural net to adjust a scalar; and
adjusting, by the neural net, the generated scalar based on a ranking indicated by the seller.

16. A server for locating buyers, the server comprising:
a processor;
a neural net trained to generate a first N-dimensional vector based on a training buyer offer feature, to generate a second N-dimensional vector based on a training seller offer feature, and to generate a scalar based on a distance between respective endpoints of the first and second N-dimensional vectors; and
memory, coupled to the processor, configured to store executable instructions that, when executed by the processor, cause the processor to:
receive a buyer offer from a buyer device of a buyer, the buyer offer including a buyer offer feature of a property for purchasing by the buyer;
receive a seller offer from a seller device of a seller, the seller offer including a seller offer feature of a property for sale by the seller;
generate a comparison metric, the generating of the comparison metric based on the trained neural net generating a scalar based on the buyer offer and the seller offer;
select the buyer offer, the selecting of the buyer offer based on the comparison metric; and
send an indication of the selected buyer offer to the seller device of the seller.

17. The server of claim 16, wherein the executable instructions that, when executed by the processor, further cause the processor to:
send a first click-through license to the seller device of the seller, the first click-through license arranged to direct the server to send to the seller device of the seller an indication of the buyer offer feature of a property for purchase by the buyer; and
send a second click-through license to the seller device of the seller, the second click-through license arranged to direct the server to send to the seller device of seller an indication of the identity of the buyer.

18. The server of claim 16, wherein the executable instructions that, when executed by the processor, further cause the processor to:
send a click-through license to the seller device of the seller, the click-through license arranged to direct the server to send to the seller device of seller an indication of the identity of the buyer.

19. The server of claim 16, wherein the executable instructions that, when executed by the processor, further cause the processor to:
to send to the seller device of seller an indication of the identity of the buyer.
